(19) United States
(12) Patent Application Publication
(10) Pub. No.: US 2008/0122839 A1
(43) Pub. Date: May 29, 2008

(54) Interacting with 2D content on 3D surfaces

(75) Inventors: Kurt Berglund, Seattle, WA (US); Daniel R. Lehenbauer, Redmond, WA (US); Greg D. Schechter, Seattle, WA (US); Dwayne R. Need, Woodinville, WA (US); Adam M. Smith, Sammamish, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/605,183

(22) Filed: Nov. 28, 2006

(51) Int. Cl. G06T 17/00; G09G 5/08

(52) U.S. Cl. 345/420; 345/163; 345/179; 345/427

(57) ABSTRACT

Various technologies and techniques are disclosed that enable interaction with 2D content placed on a 3D surface. The system determines where relative to a 3D surface an input device is located. If the input device is hitting a 3D surface, a hidden content in 2D is positioned so that a point representing the area hit on the 3D surface lines up with a corresponding point on the hidden content in 2D. For example, when a request is received for the input device position when an input device is detected at a location in a scene, the 3D surface is projected into two dimensions. A closest point is calculated on the projected. 3D surface to a 2D location of the input device. The closest point is provided in response to be used in positioning the hidden content with the corresponding point of the 3D surface.

### BACKGROUND

In two-dimensional (2D) environments, a system can tell what area a user has selected or is otherwise interacting with by simply determining the X and Y coordinates of the activity. In the three-dimensional (3D) world, however, finding the X/Y coordinate relative to the interactive 2D element on the 3D surface is not always straightforward. For example, 2D objects such as user interfaces can be placed on 3D surfaces, such as a sphere. When such 2D objects are placed on 3D surfaces, it can be difficult to deal with the user's interaction with the 2D object that is now being projected in 3D.

### SUMMARY

Various technologies and techniques are disclosed that enable interaction with 2D content placed on a 3D surface. The system determines where relative to a 3D surface an input device is located. If the input device is hitting a 3D surface, a hidden content in 2D is positioned so that a point representing the area hit on the 3D surface lines up with a corresponding point on the hidden content in 2D. In one implementation, when a request is received for the input device position when an input device that is not over the bounds of the interactive 2D element is detected at a location in a scene, the 3D surface is projected into two dimensions. A closest point is calculated on the projected 3D surface to a 2D location of the input device. The closest point is provided in response to be used in positioning the hidden content with the corresponding point of the 3D surface.

In one implementation, different processes are followed depending on whether or not a particular 3D surface has capture. For example, if a 3D surface in the 3D scene does not have capture, and if the input device hit a 3D surface, then texture coordinates are used on a 3D triangle to determine what point was hit on the hidden content in 2D. The hidden content is then moved to a position such that the hidden content lines up with a corresponding point on the 3D surface. Similarly, if the 3D surface in the 3D scene has capture, and if the input device is determined to hit the 3D surface with the capture content, then using texture coordinates and the process described previously to line up the hidden content.

In another implementation, if the 3D surface in the 3D scene has capture, and if the input device is determined to not hit the 3D surface with the capture content, then the system computes the boundary of the capture content, finds a closest point on the boundary to the location of the input device, and places the closest point on the boundary under the location of the input device.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a computer system of one implementation.

FIG. 2 is a diagrammatic view of an interactive 3D application of one implementation operating on the computer system of FIG. 1.

FIG. 3 is a high-level process flow diagram for one implementation of the system of FIG. 1.

FIG. 4 is a process flow diagram for one implementation of the system of FIG. 1 illustrating the stages involved in providing an input device location with a 3D object.

FIG. 5 is a process flow diagram for one implementation of the system of FIG. 1 illustrating the more detailed stages involved in enabling interaction with 2D content placed on a 3D surface.

FIG. 6 is a simulated image for one implementation of the system of FIG. 1 that illustrates a 2D representation of hidden content when there is no capture.

FIG. 7 is a simulated image for one implementation of the system of FIG. 1 that illustrates a 3D surface that that interacts with hidden content when there is no capture.

FIG. 8 is a simulated image for one implementation of the system of FIG. 1 that illustrates the 2D representation overlaid with the 3D surface when there is no capture.

FIG. 9 is a simulated image for one implementation of the system of FIG. 1 that illustrates a 3D surface with a button and text displayed when there is capture.

FIG. 10 is a simulated image for one implementation of the system of FIG. 1 that illustrates a 3D surface shown in FIG. 9 with a portion of text being selected when there is capture.

FIG. 11 is a simulated image for one implementation of the system of FIG. 1 that illustrates a closest edge point of where the input device is expected to be relative to the 2D on the 3D surface's orientation as shown in FIG. 10.

FIG. 12 is a simulated image for one implementation of the system of FIG. 1 that illustrates a 2D text box that has capture.

FIG. 13 is a simulated image for one implementation of the system of FIG. 1 that illustrates obtaining the edges of the image of FIG. 12 and projecting those edges back into 2D to give the outline of the 2D content on 3D in 2D.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope is thereby intended. Any alterations and further modifications in the described embodiments, and any further applications of the principles as described herein are contemplated as would normally occur to one skilled in the art.

The system may be described in the general context as an application that provides interaction with 2D content placed on 3D surfaces, but the system also serves other purposes in addition to these. In one implementation, one or more of the techniques described herein can be implemented as features within a graphics rendering program such as those included in operating system environments such as MICROSOFT® WINDOWS®, or from any other type of program or service that deals with graphics rendering. In another implementation, one or more of the techniques described herein are implemented as features with other applications that deal with allowing 2D content to be used with 3D surfaces.

In one implementation, the system provides for interaction with 3D surfaces by using hidden 2D content. The real interactive 2D content stays hidden, but the appearance of the hidden 2D content is made non-hidden and placed on 3D. The hidden content is positioned in such a way as to intercept the user's attempts to interact with the rendered appearance of the content on the 3D surface. The term “hidden content” as used herein is meant to include 2D content that is not noticed by the user because it is invisible, sized such that it is not able to be seen, located behind another object, etc. In another implementation, when any part of the 2D content requests the location of the input device or requests capture, the 3D representation of that 2D content is projected back in to 2D. The border of this projected content is then used to determine how to respond to any input requests from the captured 3D surface. The term “capture” as used herein means when 2D content requests to be notified of input device state changes.

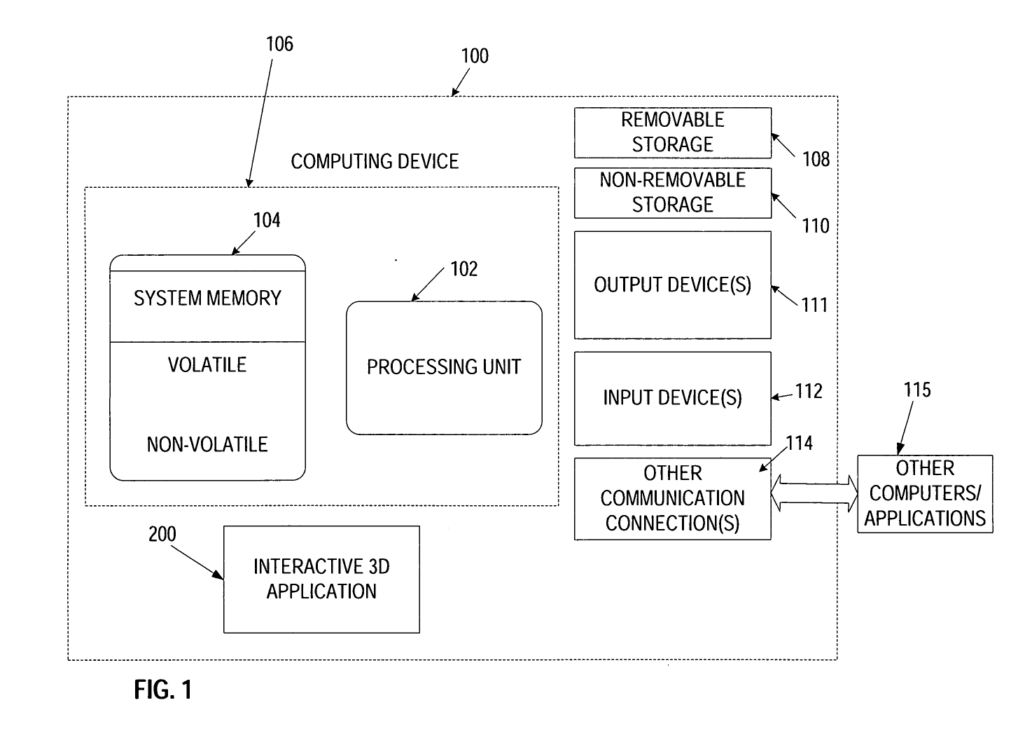

As shown in FIG. 1, an exemplary computer system to use for implementing one or more parts of the system includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106.

Additionally, device 100 may also have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

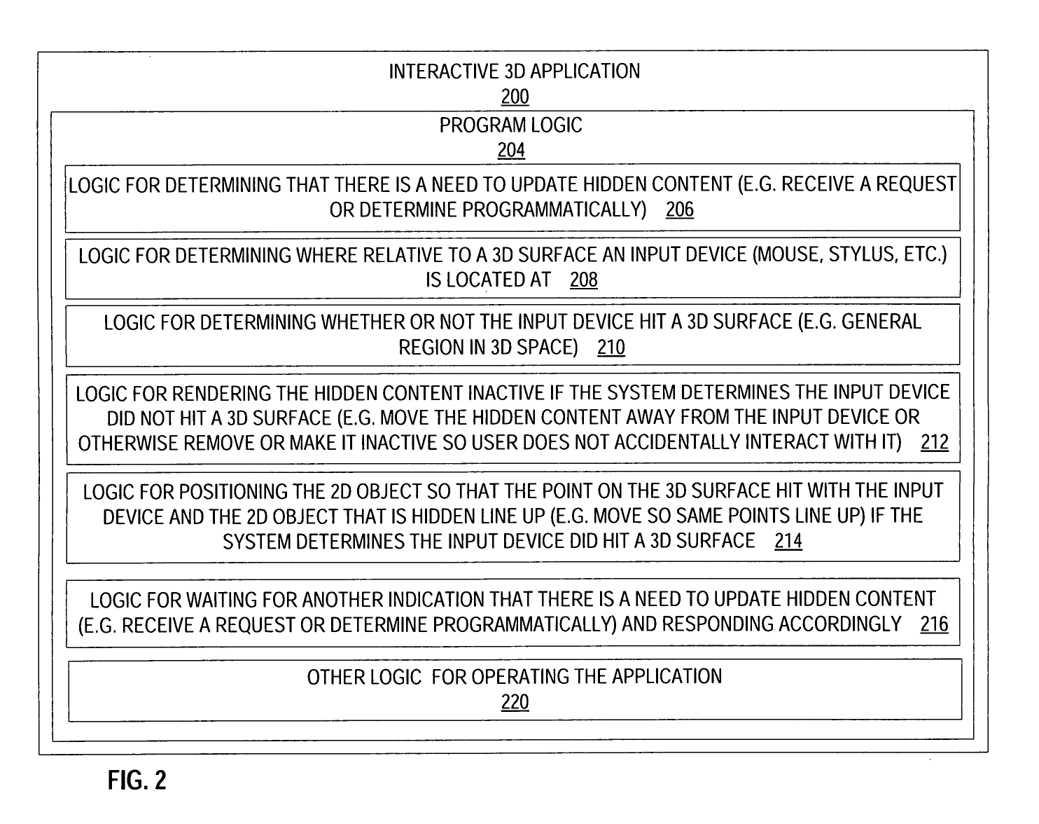

Computing device 100 includes one or more communication connections 114 that allow computing device 100 to communicate with other computers/applications 115. Device 100 may also have input device(s) 112 such as keyboard, mouse, pen, voice input device, touch input device, etc. Output device(s) 111 such as a display, speakers, printer, etc. may also be included. These devices are well known in the art and need not be discussed at length here. In one implementation, computing device 100 includes interactive 3D application 200. interactive 3D application 200 will be described in further detail in FIG. 2.

Turning now to FIG. 2 with continued reference to FIG. 1, an interactive 3D application 200 operating on computing device 100 is illustrated. Interactive 3D application 200 is one of the application programs that reside on computing device 100. However, it will be understood that interactive 3D application 200 can alternatively or additionally be embodied as computer-executable instructions on one or more computers and/or in different variations than shown on FIG. 1. Alternatively or additionally, one or more parts of interactive 3D application 200 can be part of system memory 104, on other computers and/or applications 115, or other such variations as would occur to one in the computer software art.

Interactive 3D application 200 includes program logic 204, which is responsible for carrying out some or all of the techniques described herein. Program logic 204 includes logic for determining that there is a need to update hidden content (e.g. upon receiving a request or determining programmatically) 206; logic for determining where relative to a 3D surface an input device (e.g. mouse, stylus, etc.) is located at 208; logic for determining whether or not the input device hit a 3D surface 210; logic for rendering the hidden content inactive if the system determines that the input device did not hit a 3D surface (e.g. move the hidden content away from the input device or otherwise remove or make it inactive so the user does not accidentally interact with it) 212; logic for positioning the 2D object so that the point on the 3D surface hit with the input device and the 2D object that is hidden line up (e.g. move so the same points line up) if the system determines that the input device did hit a 3D surface 214; logic for waiting for another indication that there is a need to update hidden content (e.g. receiving a request or determining programmatically) and responding accordingly 216; and other logic for operating the application 220. In one implementation, program logic 204 is operable to be called programmatically from another program, such as using a single call to a procedure in program logic 204.

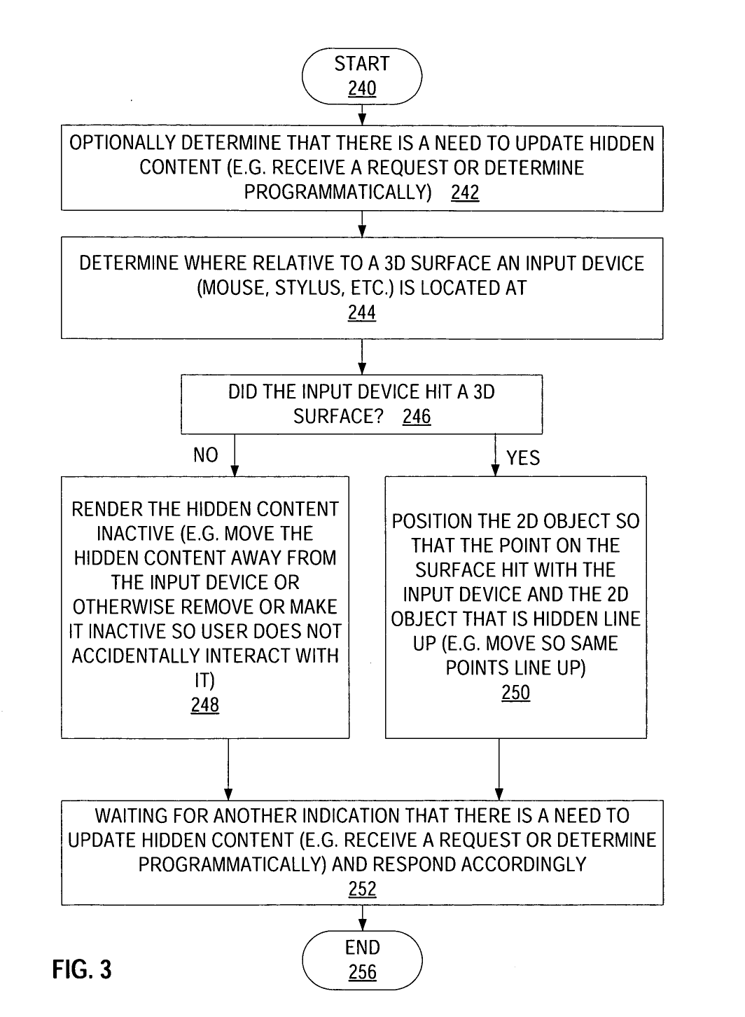

Turning now to FIGS. 3-5 with continued reference to FIGS. 1-2, the stages for implementing one or more implementations of interactive 3D application 200 are described in further detail. FIG. 3 is a high level process flow diagram for interactive 3D application 200. In one form, the process of FIG. 3 is at least partially implemented in the operating logic of computing device 100. The procedure begins at start point 240 with optionally determining that there is a need to update hidden content (e.g. upon receiving a request or determining programmatically) (stage 242). The system determines where relative to a 3D surface an input device (e.g. mouse, stylus, etc.) is located at (stage 244). If the input device did not hit (e.g. contact) a 3D surface (e.g. a general region in 3D space) (decision point 246), then the hidden content is rendered inactive (e.g. moved away from the input device or otherwise removed or made inactive so the user does not accidentally interact with it) (stage 248). If the input device did hit a 3D surface (decision point 246), then the 2D object is positioned so that the point on the 3D surface hit with the input device and the 2D object that is hidden line up (e.g. move so the same points line up) (stage 250). The system optionally waits for another indication that there is a need to update hidden content and responds accordingly (stage 252). The process ends at end point 256.

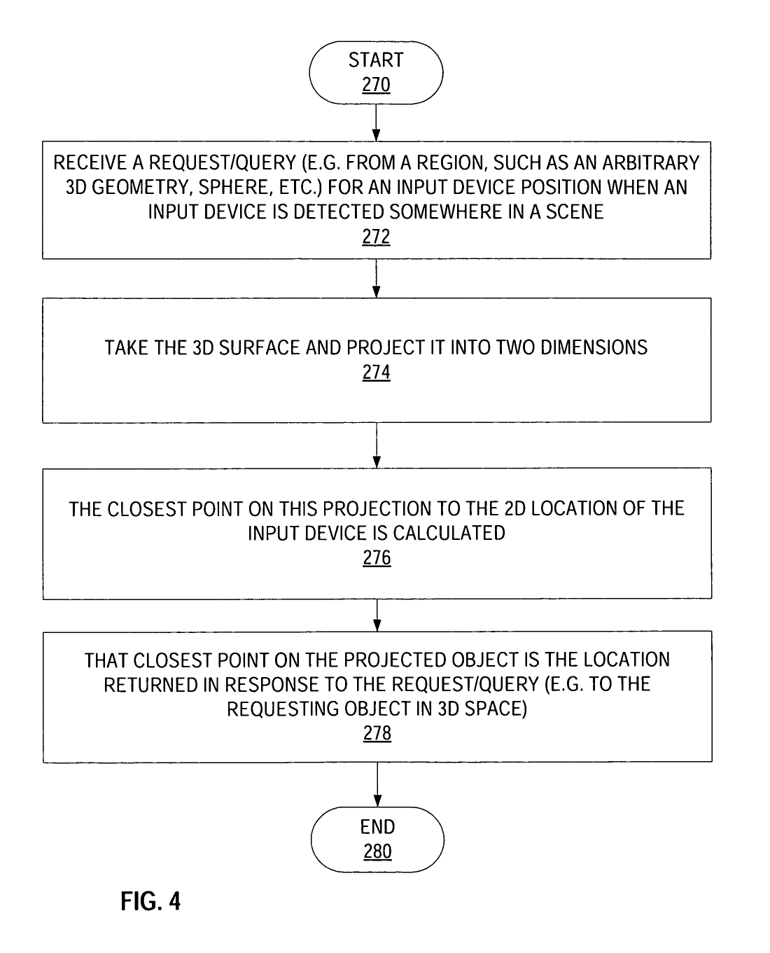

FIG. 4 illustrates one implementation of the stages involved in providing an input device location with respect to a 3D surface. In one form, the process of FIG. 4 is at least partially implemented in the operating logic of computing device 100. The procedure begins at start point 270 with receiving a request or query (e.g. from a region, such as an arbitrary 3D geometry, sphere, etc.) for an input device position when an input device is detected somewhere in a scene (stage 272). The 3D surface is taken and projected into two dimensions (stage 274). The closest point on this projection to the 2D location of the input device is calculated (stage 276). That closest point on the project object is the location returned in response to the request or query (e.g. to the requesting object in 3D space) (stage 278). The process ends at end point 280.

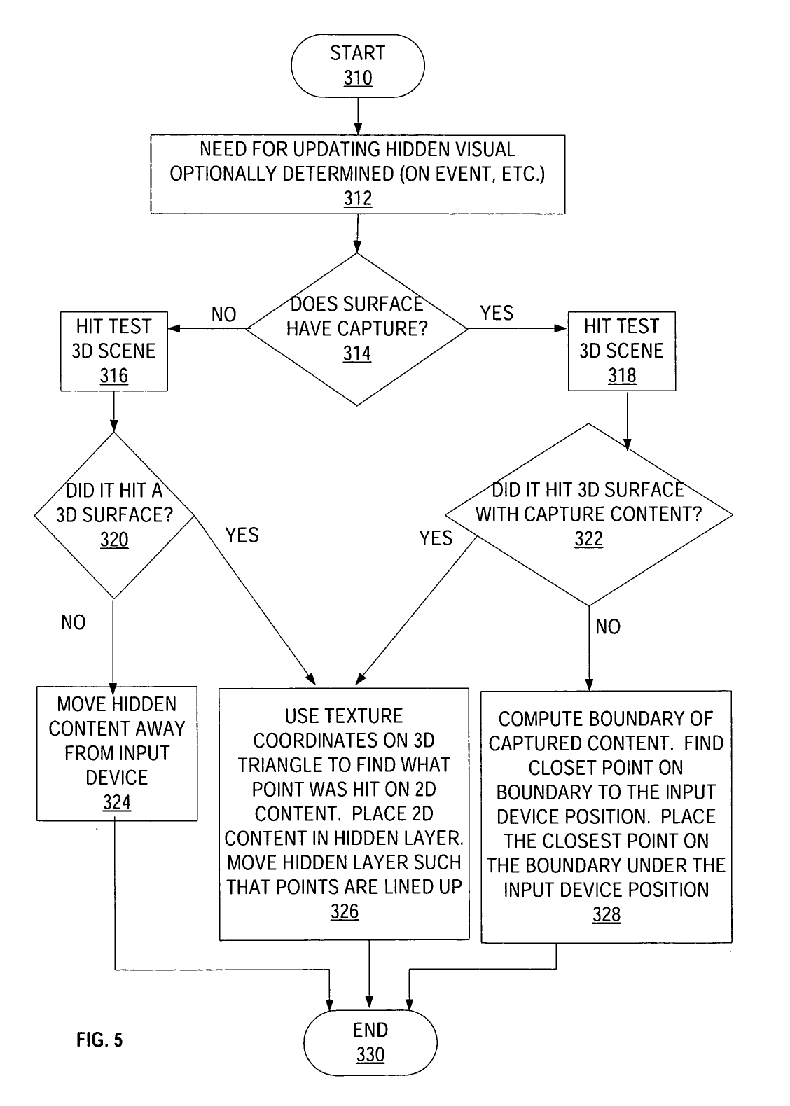

FIG. 5 illustrates one implementation of the more detailed stages involved in enabling interaction with 2D content placed on a 3D surface. In one form, the process of FIG. 5 is at least partially implemented in the operating logic of computing device 100. The procedure begins at start point 310 with optionally determining there is a need to update hidden content (“On” event, etc.) (stage 312). If the system determines that a 3D surface does not have capture (decision point 314), then a hit test 3D scene is performed to determine where relative to a 3D surface the input device is located at (stage 316). If a 3D surface was not hit (decision point 320), then the hidden content is moved away from the input device (stage 324). If the 3D surface was hit (decision point 320), then texture coordinates are used on a 3D triangle to find what point was hit on the 2D content (stage 326). The 2D content is placed in a hidden layer, and the hidden layer is moved such that the points are lined up (stage 326).

If the system determines that a 3D surface does have capture (decision point 314), then a hit test 3D scene is performed to determine where relative to a 3D surface the input device is located at (stage 318). The system determines if a 3D surface was hit with capture content (e.g. by the input device) (decision point 322). If so, then the texture coordinates are used on a 3D triangle to find what point was hit on the 2D content (stage 326). The 2D content is placed in a hidden layer, and the hidden layer is moved such that the points are lined up (stage 326). If the system determines that the 3D surface was not hit with capture content (decision point 322), then the boundary of the captured content is computed (stage 328). The closest point on the boundary to the input device position is located, and the closest point on the boundary is placed under the input device position (stage 328). The process ends at end point 330.

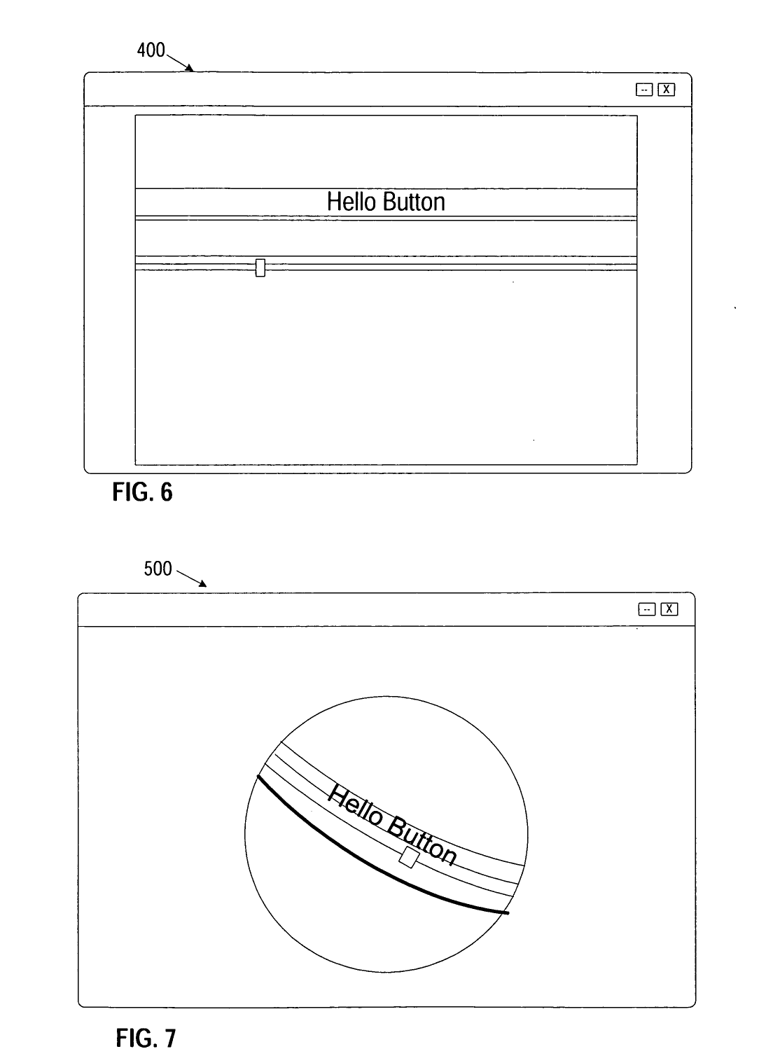

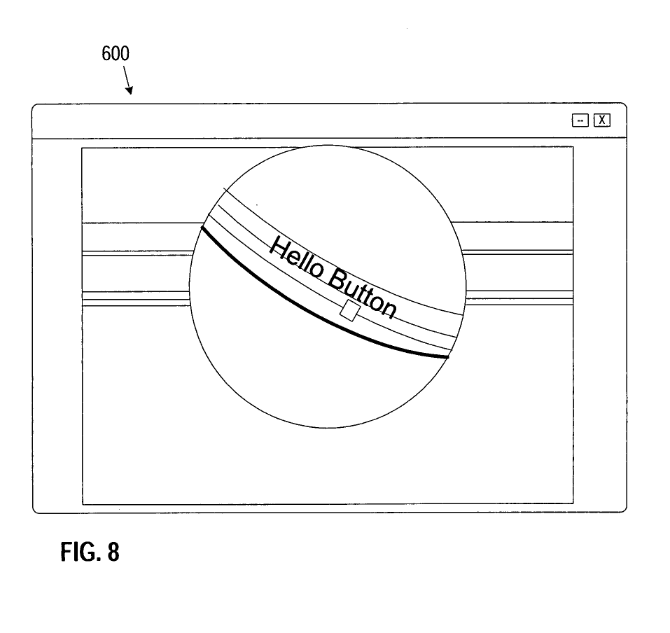

Turning now to FIGS. 6-13, simulated images are used to illustrate the stages of FIGS. 3-5 in further detail. In FIGS. 6-8, some exemplary simulated images are used to illustrate some possible scenarios when the 3D surface does not have capture. These simulated images and their accompanying descriptions provide further illustration of stages 314, 316, 320, 324, and 326 of FIG. 5 and/or of some other techniques described herein. FIG. 6 is a simulated image 400 for one implementation of the system of FIG. 1 that illustrates a 2D representation of hidden content when there is no capture. Simulated image 500 contains the content being mapped to the sphere. FIG. 7 contains a simulated image 500 that shows the image 400 of FIG. 6 being mapped to the sphere (e.g. 3D). FIG. 8 contains a simulated image 600 that shows how the hidden content is aligned so that the part of the slider the input device is over on the 3D surface is the same as that in 2D. Clicking the input device will then interact with the thumb control. Because this mapping is maintained, 3D surfaces are correctly notified when the input device enters and leaves them, as well as what part of themselves they are over. This creates an outcome of being able to interact with 2D content on 3D. In one implementation, the input device movement is tracked as the signal that the hidden content needs to be updated.

Some non-limiting examples will now be used to describe how the 2D content is mapped to the 3D surface to achieve the results shown in FIGS. 6-8. When the input device is not over the 3D surface, then the hidden layer can be positioned anywhere such that the input device is not over it. In one implementation, the desired behavior is that the 2D content on the 3D surface does not behave as if the input device was over it, and any other events should not influence it. Placing the hidden layer away from the input device causes it not to be told of movement or clicks, etc.

For the sake of example, assume that all 3D surfaces are composed of triangles, and that all triangles have texture coordinates associated with them. Texture coordinates specify which part of an image (the texture) should be displayed on the triangle. For instance, assume that texture coordinates are in the range of (0,0) to (1,1), where (0,0) is the upper left corner of the image, and (1,1) is the lower right corner of the image. Then if the texture coordinates are (0,0), (1,0), and (0,1), then the upper left half of the image is displayed on the triangle. Further, assume that the 2D content that is displayed on the 3D surface can be represented as an image, and that this image is the texture for the 3D surface it is applied to. For instance, FIG. 6 can be considered the texture, and the texture coordinates are what causes it to wrap around the sphere, as indicated in FIG. 7.

Now, when the input device is over the 3D surface, a ray is shot in to the 3D scene to see what part of the 3D surface it intersects. This can be done with many standard techniques. Once the system knows what was intersected, the point on the triangle that was hit as well as the texture coordinate for it can be determined. Once the texture coordinate is determined, since the texture is also known, then the system can map from the texture coordinate to a location on the 2D content. This location is the exact point that is over on the 3D surface. To position correctly, the system moves the hidden content such that the location that was computed in the previous part is directly under the input device location. The point over the 3D surface is directly under that same location on the hidden content, both of which are directly under the input device. Thus, if the user clicks or otherwise inputs from this position, they will be clicking/inputting the exact same point on both the hidden content and on the 2D content that is on the 3D. Also, when the input device moves, due to the positioning, both the hidden content and the 2D representation of it on 3D will be told of the input device movement over the exact same points.

Turning now to FIGS. 9-13, some exemplary simulated images are shown to illustrate some possible scenarios where the 3D surface has capture. These simulated images and their accompanying descriptions provide further illustration of stages 314, 318, 322, 326, and 328 of FIG. 5 and/or of some other techniques described herein. In one implementation, correct hidden content positioning can become more complicated when a 2D element on 3D gains capture. As one example, in 3D, due to the projection of 3D on to a 2D plane, the input device's position actually corresponds to a line in 3D space. In addition, the 3D surface with capture could also be mapped to any arbitrary geometry. Thus, when the input device is over the 3D surface, hit testing indicates where the input device is relative to the 2D visual. When it is off the 3D surface, due to the above issues, there is no longer a straight forward answer to this question: the 2D point corresponds to a 3D line and the 2D content could be on arbitrary geometry. Also, because a 3D surface has capture, it wants to receive all events. Before, when capture was not involved, the system only needed to be sure that the input device was over the correct object at all times. Now, with capture, the system needs to position the hidden content so that it is in the proper position relative to the object that has capture. The simulated images shown in FIGS. 9-11 illustrate this in further detail.

In one implementation, one possible solution to this problem is to reduce the 3D problem back to 2D. In the normal 2D case, the transformations applied to the content can be used to convert the input device position to the content's local coordinate system. This transformed position then lets the content know where the input device is relative to it. In 3D, due to the many orientations of the geometry and texture coordinate layouts, it can sometimes be difficult to say where a 3D point is in the relative coordinate system of the 2D content on 3D. In one implementation, to approximate this, the outline of the 2D content on 3D, after it has been projected to screen space, is computed and then the input device is positioned based on this projection. FIGS. 9-11 illustrate this in further detail.

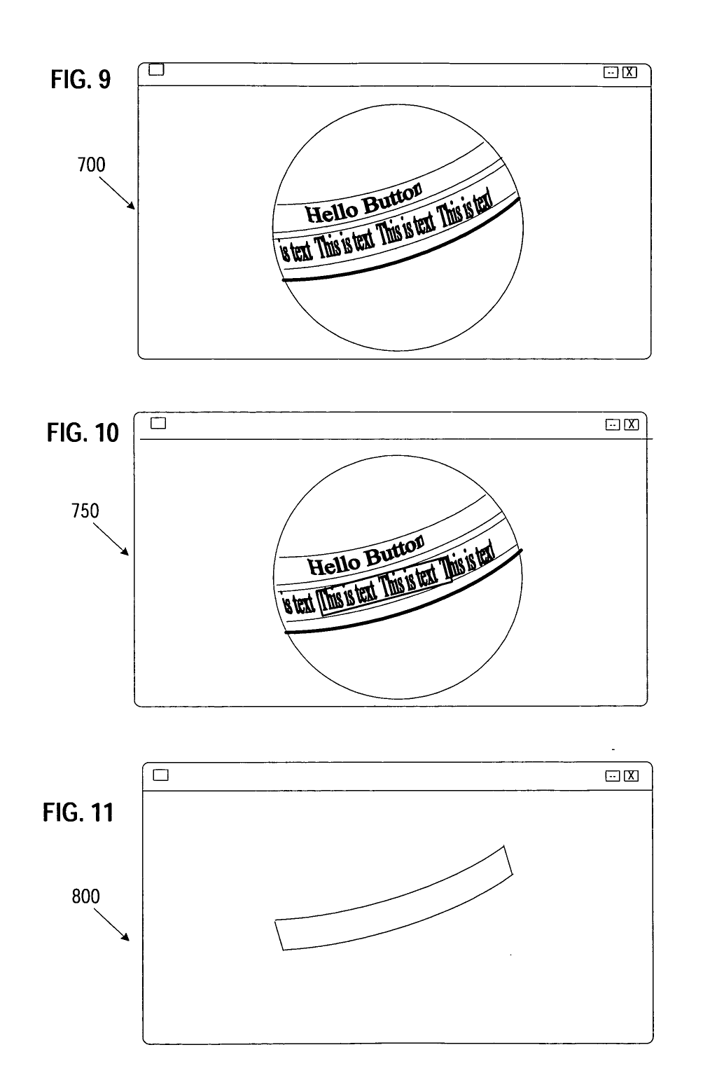

The simulated image 700 of FIG. 9 shows the 2D content on 3D. The simulated image 750 on FIG. 10 shows that the text has been selected, and the input device is moved to a point off the object. FIG. 11 shows a simulated image 800 with an outline of the text box (i.e. the object that has capture). This outline is then used to position the hidden content.

After the outline is available, the closest point on this outline to the input device position is computed, and then this point on the outline is considered what was “hit” and it is placed under the input device position. In the example shown, the highlighting is performed up to the “T” in the middle of the image 750. Since the input device is placed by the closest edge point, the interaction tends to behave as it would in 2D, since the hidden content is positioned based on what the input device is closest to on the 2D content on 3D. By placing the hidden content at the closest edge point, the system is indicating about where it expects the input device to be relative to the 2D on 3D surface's orientation.

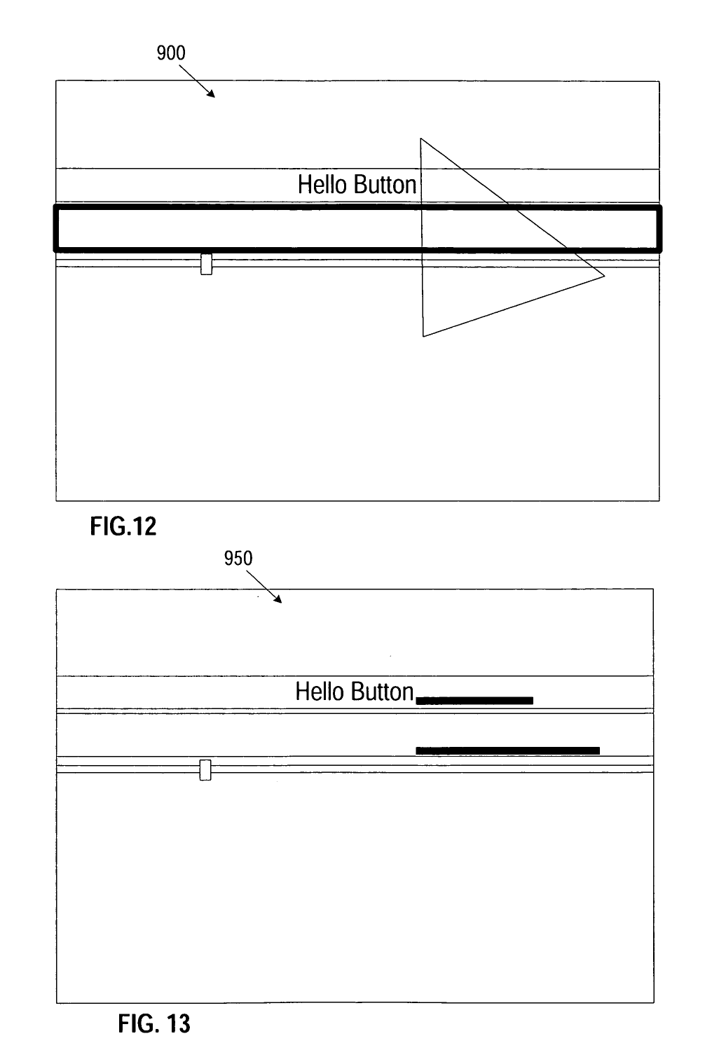

To actually perform the process described with reference to FIGS. 9-11, the system computes the bounds of the object with capture relative to the 2D content it is contained within. As an example, consider the 2D content shown in FIGS. 12-13. Assume the text box has capture. In FIG. 12, the bounds of the text box contained in image 900 are outlined in bold. These bounds can be converted to texture coordinates since the bounds of the 3D surface with capture are known, and the size of the 2D content as a whole is also known. With the texture coordinates, the system can then examine every triangle of the mesh the 3D surface is on, and look for those triangles that contain texture coordinates that intersect the boundary coordinates. For example, suppose there is a triangle, and the triangle has texture coordinates is drawn as shown on the 2D content in FIG. 12. The system checks to see if the triangle's edges intersect with the bounds of the 3D surface with capture, which they do in this case (they intersect with the text box—which has capture). If the triangle is facing the viewer, and any of the boundary edges intersect it, then the edge where the boundary edge and the triangle intersect are added to a final list. The edges that would be added are shown in image 950 of FIG. 13. By performing these steps, the visible edges that intersect the captured 3D surface's boundary are determined.

In one implementation, the system also tracks which triangles are facing the viewer and which ones face away. If there are two triangles that share an edge, one facing the user and one facing away, then the system can also add the part of this shared edge that is within the captured 3D surface's boundary to the final list. This can be necessary so that the visible boundary is computed. As a non-limiting example of this situation, consider the sphere in FIG. 9. Both the left and right edges are silhouette edges (i.e. an edge has both a visible and an invisible triangle). The system adds these to compute the entire visible outline of the captured 3D surface (as shown in FIG. 11). Otherwise, the far left and far right images would be missing, and the full outline would not be computed. Once the list of edges is determined, they are then projected back to 2D. This gives the outline of the 2D content on 3D in 2D. Then, the point on these edges closest to the input device is calculated. This point has a texture coordinate of its own, and this texture coordinate is then used, as above, to position the hidden content. Depending on the behavior desired, the border of the captured 3D surface can be thickened, if it is necessary to move further away from the captured 3D surface.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the client and/or server arrangements, user interface screen content, and/or data layouts as described in the examples discussed herein could be organized differently on one or more computers to include fewer or additional options or features than as portrayed in the examples.

What is claimed is:

1. A computer-readable medium having computer-executable instructions for causing a computer to perform steps comprising:
determine where relative to a 3D surface an input device is located at; and
if the input device is hitting the 3D surface, position a hidden content in 2D so that a point representing the area hit on the 3D surface lines up with a corresponding point on the hidden content in 2D.

2. The computer-readable medium of claim 1, further having computer-executable instructions for causing a computer to perform the step comprising:
render the hidden content inactive if the input device did not hit the 3D surface.

3. The computer-readable medium of claim 1, further having computer-executable instructions for causing a computer to perform the step comprising:
determine that there is a need to update the hidden content before determining where relative to the 3D surface the input device is located.

4. A method for providing input device location with respect to a 3D surface comprising the steps of:
receiving a request for an input device position when an input device is detected at a location in a scene;
projecting a 3D surface into two dimensions in the scene;
calculating a closest point on the projected 3D surface to a 2D location of the input device; and
returning the closest point in response to the request.

5. The method of claim 4, wherein the input device is a mouse.

6. The method of claim 4, wherein the input device is a stylus.

7. The method of claim 4, wherein the request is received from a region.

8. The method of claim 7, wherein the region is an arbitrary 3D geometry.

9. A computer-readable medium having computer-executable instructions for causing a computer to perform the steps recited in claim 4.

10. A method for enabling interaction with 2D content placed on a 3D surface comprising the steps of:
determining that a hidden content in 2D that is in a 3D scene needs updated;
determining a location of the input device in the 3D scene; and
if a 3D surface in the 3D scene does not have capture, then determining if the input device hit the 3D surface in the 3D scene, and if the input device did hit the 3D surface, then using texture coordinates on a 3D triangle to determine what point of a plurality of points was hit on the hidden content in 2D, and moving the hidden content to a position such that the hidden content lines up with a corresponding point on the 3D surface.

11. The method of claim 10, further comprising:
if the 3D surface in the 3D scene has capture, then determining if the input device hit the 3D surface with a capture content.

12. The method of claim 11, further comprising:
if the 3D surface in the 3D scene has capture, and if the input device is determined to hit the 3D surface with the capture content, then using texture coordinates on the 3D triangle to determine what point of the plurality of points was hit on the hidden content in 2D, and moving the hidden content to the position such that the hidden content lines up with the corresponding point on the 3D surface.

13. The method of claim 11, further comprising:
if the 3D surface in the 3D scene has capture, and if the input device is determined to not hit the 3D surface with the capture content, then computing the boundary of the capture content, finding a closest point on the boundary to the location of the input device, and placing the closest point on the boundary under the location of the input device.

14. The method of claim 10, wherein the hidden content is determined to need updated upon the occurrence of an on_move event from the input device.

15. The method of claim 10, wherein the input device is a mouse.

16. The method of claim 10, wherein the input device is a stylus.

17. The method of claim 10, wherein the need to update the hidden content is determined upon receiving a request from a region for the location of the input device.

18. The method of claim 17, wherein the region is an arbitrary 3D geometry.

19. The method of claim 10, further comprising:
if the 3D surface in the 3D scene does not have capture, and if the input device is determined to not hit the 3D surface in the 3D scene, then moving the hidden content away from the location of the input device.

20. A computer-readable medium having computer-executable instructions for causing a computer to perform the steps recited in claim 10.
